(19) United States
(12) Patent Application Publication
(10) Pub. No.: US 2005/0210270 A1
(43) Pub. Date: Sep. 22, 2005

(54) Method for authenticating a user profile for providing user access to restricted information based upon biometric confirmation

(75) Inventors: Santu Rohatgi, Lutz, FL (US); Peter W. Rung, Lutz, FL (US); Ryan R. Rohatgi, Lutz, FL (US)

Correspondence Address: LARSON AND LARSON, 11199 69TH STREET NORTH, LARGO, FL, 33773, US

(73) Assignee: CEELOX, INC.

(21) Appl. No.: 11/070,484

(22) Filed: Mar. 2, 2005

Related U.S. Application Data
(60) Provisional application No. 60/554,885, filed on Mar. 19, 2004.

(51) Int. Cl. H04K 1/00

(52) U.S. Cl. 713/186

(57) ABSTRACT

A method and apparatus for authenticating a user profile and for providing user access to restricted information based upon biometric confirmation disclosed. Multiple authorized biometric inputs may be coupled to multiple applications, each input initiating a respective application as well as authenticating the user of that application so that the presentation of a biometric scan yields the initiation of the application as well as the authorization of the user to access the application and its associated data.

### PRIOR APPLICATIONS

This U.S. nonprovisional application claims priority to U.S. provisional application Ser. No. 60/554,885, filed on Mar. 19, 2004.

### BACKGROUND OF THE INVENTION

1. Field of the Invention

This invention relates to a method for high level user authentication for providing instant access to restricted information and secure networks. More particularly, it relates to a method for authenticating a user profile, exclusively associated with the user's identity, and establishing the highest probability for truthfulness through a biometric characteristic measurement.

2. Description of the Prior Art

There are essentially three levels used in establishing the identity of a person requesting access to a secure location, documents, and files. They are from bottom to top identification, verification and authentication. The process of identifying an individual to able access to secure rights, is usually based upon on authentication username/password at the top level. In a more sophisticated system, encryption is added to the authentication level. Security system authentication is distinct from authorization, which is the process of giving individuals access to, system objects based on their identity. Authentication merely ensures that the individual is who he or she claims to be, but says nothing about the access rights of the individual. By authenticating the person, they are then usually allowed to proceed where their rights permit them to. In the word of digitalization and computer networks, this may be the last stopping point before total access is provided. If authenticated in the digital world, someone can be inside a secure corporation and have access to all of their files without physically ever being there. Hence, there is a critical need to ensure that no mistakes are made.

Current technology, and all of its advancements, continues to rely upon User Name/Password combinations to allow access to the most restricted information and most important financial transactions. The concept of encrypted User/Password is valid but has flaws. Persons with computer knowledge can break the encryption easily and steal the identities of those having a known high probability for truthfulness through User Name/Password authentication. The result is complacent trust, that the true identity has been established through encrypted authentication. A higher standard of identity authentication is clearly needed.

The Internet commerce, the personal PC, the work PC, and the other complexities of our technical legacy world creates multiple User Name/Password for a single user, which is extremely difficult to remember, and hence forces the User to use sticky note pads, diaries, or any other unsecured methods. In this environment, another person watching the User has the capability of stealing the User Name/Password and using it to the detriment of the company or individual alone. Meanwhile, the world continues to become more complex by mergers and acquisitions. The major corporations have numerous business applications that are not integrated and non-compatible. This creates an issue that adversely impacts productivity. Not only do employees continue to sign-in and sign-off from business applications, but they continue to keep manual records of User Name/Passwords, which that just defeats the purpose of automation and security and is not compliant with new regulatory statutes in the measurement of IT operational risk. Additionally, companies employ persons just to manage the issues with passwords, such as inaccurate and lost passwords thereby adding cost to their overhead.

The technology advancements have yet to create an ideal world where the people can create a profile only one time and continue to use that same profile at home, work, the Internet, and Intranets without compromising the security of transactions. However, Biometric authentication provides that possibility. But what is biometric? Strictly speaking it is the study of measurable biological characteristics. In the world of computer security it is so much more and known to many as biometric encryption.

Biometric Encryption is the process of using a characteristic of the body as a method to code or scramble/descramble data. Physical characteristics such as fingerprints, retinas and irises, palm prints, facial structure, voice recognition, and DNA matching can all be used as methods of biometric encryption. Since these characteristics are unique to each individual, it is an ideal measure of true identity since a biometric trait cannot be lost, stolen, or recreated, at least not easily.

Possibly the most well known biometric measurement is the use of fingerprinting by law enforcement agencies for identification of criminals. This process, however, began as a highly manual function where individuals would spend weeks or months trying to match the hard copy fingerprints that were on file with those obtained elsewhere. In many cases, matches were difficult if not impossible to make, and it was not uncommon for misidentifications to occur. With the advancements made in computer technology, some agencies began to construct archives electronically that could allow that matching process to occur much faster and with a much lower error rate as the computer could distinguish better than the naked eye the subtle traits that occurred in the fingerprints. The next step in the evolutionary process of biometric encryption came from the desire not only to match an individual's data with the individual, but also to restrict access to that person's information to those who should have such access. It is the restriction to access of information and to the portals of computer networks which has driven the invention of this application to the forefront.

Biometrics is a form of encryption and encryption is a mathematical process that helps to disguise the information contained in messages that is either transmitted or stored in a database. To date though, most encryption still relies on key type systems wherein one key is at the sending end and the other is at the receiving end. There is a need to improve and make a system that permits for single-sign-on for those persons that are known for a high probability of truthfulness and have been authenticated by a biometric trait.

Further, there is currently no known system that permits those that are known for a high probability of truthfulness and have been authenticated by a biometric trait to have their user profile or role split into many roles. For instance, a person who works in a call center environment may be supporting several companies that may require different profiles, and different User Name/Password. The person will need to sign-on and sign-off every time depending on the client calling for help. A single-sign-on method and device is needed utilizing a profile creation method that permits role playing and switching based upon a highest probability for truthfulness measurement through biometrics.

A person using a workstation in a corporate environment may be able to steal important company information and data very easily. This problem is thought to be solved by having employees sign Confidentiality documents and any other document that the company desires. However, the company has no methods in place to check theft on a daily basis. What is needed, and not seen anywhere in the prior art, is an integrated system to prevent corporate theft by identity theft through a required single-sign-on method and device for establishing the identity of a person wherein user profiles are matched with biometric authentication and permission for the highly probable truthful users to split their profiles into role players allowing the switching of roles, but always under one identity, at the their discretion based upon a biometric highest probability for truthfulness measurement.

In today's world, all types of electrical devices exist that fall under a category generically called computing devices. A computing device is simply any electronic device capable of making a logical deduction in response to a command directed thereto and then executing, in a well defined manner, an answer, a response, or instruction based upon its deduction and in accordance with a pre-defined set of instructions.

Computing devices have been evolving at a rapid rate since their early days of infancy and are now an integral part of our lives. Their evolution from simple devices (i.e., calculator) to complicated and sophisticated operational machines (high speed network servers) has been advanced by allowing the computing devices to make complicated and critical decisions without requiring interference or assistance from a human user or operator. Many of the computing devices that are in use today make incredibly fast decisions (execution) based upon extremely fast calculations that are compared against pre-defined instructions stored within the computing device. It would be, in almost all instances, wholly impracticable, if not impossible, for any user to be involved in these fast executing processes.

The need for fast calculations, has lead to faster computing devices powered by extremely fast processors and is still partly driven by a desire to obtain increased productivity through use of faster computing devices. Higher productivity within in a specific company usually equates to higher revenues which can increase profitability of the company. All areas of commerce and business, whether intra- or interstate can benefit financially by a productivity increase. Even if the purpose of a company is not to increase productivity, there are still huge benefits from increased levels of processing and communication. The mere efficient movement and proper secure storage of paper documents in a digitized form on a fast moving computer network could bring a company into compliance with new Federal and State laws instituted in the pass few years. Governmental and non-governmental agencies can surely benefit from higher productivity by processing information faster and providing services quicker to the people in need of such information and services. A more efficient government usually means a savings to the tax payers.

Because of the increasingly fast processing speeds in modern computing devices, much faster and less complicated communication links between any two or more compatible computing devices have also been on the rise (as one example, Blue tooth: a short-range radio technology simplifying comm links among Internet devices and between devices and the Internet as well as simplifying data synchronization between Internet devices and other computers).

Certainly speed of processing in the computing devices, new high-speed and simplified communication protocols and the ability to take full advantage of the Internet with newly emerging tools is making it possible for many companies to reach exceptional goals quicker than expected. However, these accelerated speeds in processing and communications have also brought trouble . . . particularly with the Internet.

Not many people will argue that the Internet has made it easier for people to receive, at a bare minimum, tons of free and useful information at their fingertips. The ability to purchase products quickly and have them shipped directly to your doorstep using E-Commerce is a wonderful advancement in retail and wholesale marketing of merchandise. However, with the sweat comes the sour. The Internet, with all of its good uses and responsible people users of the worldwide gateway, there are those who exploit the Internet's weakness with malicious intent. Devious individuals infect networks with worms to eat away at computer systems unbeknown to system administrators until it is too late to stop or contain. Or, they loose viruses to see how far they travel before being caught and eradicated as it ruins people's computer systems. Steps can be taken to avoid these results seen in the prior art by implementing an easy and quick routine which would provide you with full and instant restoration by using a mobile one click device.

Then there are individuals whose intent is more criminal in nature. For Instance, hackers break into corporate networks to steal vital documents and other trade secrets, customer lists, ways of doing business and more. Fraud against financial institutions is staggering where the sole intent of the hacking party is to steal money. And then there is identity theft, the ability to assume someone else's identity and hence their life (the being of which the real person has actual possession). The stolen life is carried as far as possible assuming debt and committing fraud just to be thrown away thereby leaving the actual being to sort out the mess. A heavy presence on the Internet with little or no concern is what opens a person to identity theft from the Internet and can be avoided with a level of privacy, which can not be done in the prior art as to our knowledge. Also, when carrying anything less than your whole environment, caution should be taken or utilization of a mobile and portable back-up storage medium as in the present invention should be employed.

These above listed concerns have made many people, and most big corporations, step back and insulate (through the use of multiple firewalls) or in some extreme cases totally or partially isolate themselves, leaving minimal, if any, portals of connectivity to the outside world. This clearly hampers productivity, one of the most rewarding aspects of the Internet, by making it more difficult to get into a vendor's site and to sales representatives of that vendor. Or, inversely, making it difficult for employees or a vendor to get out of their own network. In other words, corporations are building sophisticated barriers around their networks in the form of multiple stacked firewalls to keep a small but deadly and malice hacking element out of their network at a cost of lowering their productivity by hampering inbound paying customers and outgoing sales representatives from breaking down the barriers quick enough.

Improvement are clearly needed here allowing vendor sales representatives, at the least, to physically remove themselves from the network environment of the their employer, go out into the field and make new contacts and sales, all the while having full access to that which they normally have at their disposal when at work and at home. In other words, let them go into the field, but provide them the tools needed by giving them an ability to work and make sales just as they do at their desk (i.e., give them all the capabilities of a networked PC but don't make them carry one into the field). Of course, incompatibility of operating systems, a lack of commonality between applications and a loss of crucial settings, preferences, shortcuts and the like can inhibit this portable device an its operator from doing the best job they can the field. Nothing currently in the prior art permits a corporation to give this ability as set forth above to their representative.

In addition to “physical” barriers, sophisticated identity schemes are now being employed all around the world to help secure networks from attacks. Identification, verification and authentication are all steps employed within truth of identity equations which are used to take a person being tested from bottom to top if they have clearance and are requesting access at that time. The number of equations that can be built from these three steps alone permits multiple levels of security to be built. Add in a level of encryption to the authentication level and a more secure place most likely will appear. But it will certainly hamper movement about the offices and added cost to implementation.

In order of accepted value, most corporations use identification at the bottom, verification next above that and authentication is at the top. Use of such schemes certainly keeps out more instances than not, but at what cost? It is almost impossible to measure lost revenue and overall wages for all employees, to include the officers, due to long and arduous implemented truth of identity analysis that each person must go through to get to their desired location. This merely emphasizes that improvements are needed in truth and identity analysis if implementing as such a scheme is where the company wishes to go to have a level of comfort that people desire by having any security measures.

In order that separate corporations that are working together, who may have different platforms, some type of translator is needed for those two corporations to talk. This is a problem which needs to be addressed and fixed. A universally compatible platform does not appear to exist as of yet and does not seem to be on the forefront of the agenda. Some type of temporary interface which allows platforms of different environments establish a link, albeit a short one, would be an improvement. An element of the present invention to be disclosed in full detail below will allow just such link through a proprietary syncing process.

Further, even in situations of compatible platforms and operating systems, communication between two computers of different networks must establish a protocol. That is best done by one taking a dominant role while the other take a lesser subservient role. This may cause problems with the subservient computer wherein certain settings of the subservient computer are forced to change to establish the handshake.

The result is that the visiting environment (or guest) has now been compromised, and there is now uncertainty as to the extent of what changes had been made and have certain preferences and other user defined settings which were unique to you, or in its combination overall. In essence, the environment that has been defined by the guest user environment has been altered and has become that much more identifiable due to unwanted and unforeseen tagging, manipulating and adjusting of first computers. This practice is common placed result in a environment such as the Internet wherein computers are connected by extensive networks that have been created. It should be understood, however, that use of the words “computing device” in this application is not meant to be limited to just computers, but includes any electronic device that is capable of making even the smallest of logical decisions based upon a command and execute a response in accordance thereto. Other computing devices include cell phones, PDAs, laptop computers, tablet PCs, MP3 players and Recorders and even watches to just name a few.

What is important to learn from the user environment being manipulated and forced to accept some level of change, albeit a minor change, on any one given occurrence, that along with the user of the computer making his own set of changes, the user environment begins to grow at a rate proportional to the amount of activity by the user on computer and its exposure to all types of intranet networks like the Internet. The user environment essentially becomes a being, having measurable characteristics like that of a human being, which is really just extension of the user. This can present huge advantages to the computer user for exploitation thereof, but at the same time also subject him to huge environment computer to dire consequences. If the user understands that what may be happening to his “computer being”, he then has a better chance of minimizing detrimental effects through control. In the remaining portion of this application, I will substitute the phrase “user environment” with “profile” understanding that they mean the same thing and could be user interchangeably if necessary. Notwithstanding, profile will mean computer user environment leaving to go somewhere.

It is interesting to note however, that a computer profile can be analogized to a natural living being. The analogy is easier to recognize in that a natural living person takes his “being” (the essence of what he is, his mind and his body—everything about him) with him at all times and he always will until passing of life. Accordingly, decision process as to where he will take his being, what he will do with his being when he arrives at his destination, and to whom will he expose his being as he moves through locations are generally controlled by the person who possesses the being. Obviously, there are periods in a person's life which limits their control over their entire being, holding only a portion of it, such as when a person is a small child under the supervision (control) or her parents.

In the case of adults however, wherein one has the necessary or adequate abilities to take care of himself will at some point, statistically, make a decision that exposes him, and hence his being, to an unforeseen attack which may have detrimental effects upon the essence of his life which of course directly him. In like manner, but in reverse order, computers can too be exposed to unforeseen attacks which first effects the profile and then the operator since it his preference settings, data, application, and/or operating system within the profile that is potentially corrupted, lost or destroyed. In either case, the outcome of the decision may cause a more prudent practice in a subsequent decision making process if another similar or exact situation arises. In other words, experiences that have affected the being usually play in some later decision making process (i.e., move with caution) as a person continues to travel through life with their unique being that defines them. Avoidance from future attack will surly be considered if a viable options are presented.

The inverse can also be true. That is, decisions by a person which result in an increased level of satisfaction, a feeling of success or financial gain, an increase in perceived knowledge or just a general sense of pleasure all have the potential to encourage a person to expose his being in ways that they would not have considered before. As confidence builds, complacency tends to enter the decision making process and unknowingly introduces a variable of risk which may be perceived as acceptable when compared to the potential for personal gain.

As a result of taking more risk (implementing less security), a person's being, and in particular, a specific measurable characteristic or a set of combined measurable characteristics, when exposed, permitted to be analyzed and qualified, may define the being, and hence the person, leading him to a place where decisions are made by others and completely out of his control. The fact that the person (the being) is actually who he says he is may not be adequate, requiring additional identification or even verification. Then, even if he is the person he says he is, can he be trusted with the subject matter possessed or controlled by the decision maker (decision maker's unique definable being or other portion of his being representing great value—family). Or, regardless of trust, will the decision maker take his own set of risks by allowing for persons of unverified identity to enter a restricted area of protection and having unique importance. All of the above issues relate to identifying, verifying and authenticating a person and deciding whether how much scrutiny the person being analyzed should be put through before access is provided. If instant, almost undeniable truth of identity can be provided, should authentication be instantly provided along with elimination of identification and verification? Possibly, it depends to what they will be provided access? What part of the being or being's most valued asset will be exposed? Access to the decision maker's children with no supervision would most likely require absolute authentication along with verification and authentication. While, absolute authentication may be provided immediately when access to the home is provided with no-one present at the time of access thereby ensuring complete safety of all family members because the parents have their children in their control.

Security issues, such as those listed above, are typically balanced by comparing cost and time to establish verification (absolute truth) against severity of any exposure to untruthfulness, malicious and/or devious intent or outcomes of statistical improbability.

Exceptions exist for all generalizations in life and transcend directly into the world of computing devices. Therefore, actions taken or not taken by a person, whom someone uses to define characteristics of that person, should not be used as an absolute determining factor to prove truthfulness.

Mistakes regarding a person's being can easily be made due to human error input at a database input layer or at some other automatic level (far from any human control) which provides the database, and therefore an interpreter of that data, with inaccurate information (so called “corrupted data”). Still further, deceptive and intentional malice can be inflicted against a person's being as a result of identity theft, establishing an untrustworthy appearance, which may not even be known to the person whose identity has been stolen. It is for these reasons, that variables should always be considered and entered, when appropriate, into any equation that is being used to verify the truthfulness of a person's identity BY action or inaction. Simply put, a person making judgment of another must always understand that there is not one absolute measurable qualifier of the person's being that can define each and every person. In fact, different people have different characteristics which yield different levels of truthfulness and so placing everyone under one truth verification equation is problematic at best.

However, if a measurement can be made that provides the highest probability of verified identity and in the shortest amount of time, then such equation should be employed as the preferred manner of verification. Cost of implementation will most likely remain the largest factor but should be absorbed if such a measurement could be given at a high accuracy rate. And of course, where is the verified person headed and what is he to see (access to what?) will always remain an important factor, since even the highest verified and truthful people do not need to be privy to all secure and protected area of control. Consistency within any organization having a policy that justifies the person's access will help to ensure that any mistakes are minimized. And, that way, those people implementing the test for truthfulness to establish verification can ultimately be responsible for any lapses in security.

The world is now inundated with computing devices dominating many important aspects of our lives. Computers in particular are taking a larger role almost every day in business on an international level and in our personal lives. The use of such has become a place where computing devices in many instances replaces the natural being with a computer being specifically used in certain situations. And the process of making decisions regarding access to information and verification of identify (what is the truth?) are comparable and made all the time, today. However, they are not always made easily in the world of computers since decisions in many instances must be made instantly wherein time is of essence and can not be re-check against what is apparently the most truth measurable quality.

Computing devices, and in particular computers, connect to the Internet directly or by a LAN or Intranet, and are found in homes, personal work spaces and in office workstations and have all begun to form a personal identity (or unique user environment) which is arguably, or even undeniably, unique and personal to the person operating that or in control of the computer. Accordingly, the computer has the ability to form a profile (a user environment) which is representative of the person or user. Yet, the ability to move that unique user environment from one place to another is almost impossible outside of lugging your entire personal computer or other computing device with you. This, of course, is impracticable in many instances even when taking a laptop.

The formation of the user environment does not have to occur to those computers only on networks, those which are not even tethered to the Internet build a profile (a being) as they use the computer. The computer user may still desire to configure his own user environment, to make using that computer unique to his desires even though he is not out on the Internet or communication with others a trough some mother connection medium. In either case, through more and more use of the computer, a measurable profile of identifiable characteristics, uniquely related to the specific computer, based upon both intended and unattended actions by the user is formed. And when present on an open network like the Internet, this profile can grow quickly. And in reverse though, the lack of presence or time on an open network, like the Internet, can minimize the computer and its being (user environment) by lowering its presence, if minimizing risk is an option. In a sense, each computer has the ability to become its own being having measurable and quantifiable characteristics like that of the natural person as described above.

However, no technology in the prior art permits someone from moving about the Internet, or circumventing it completing with total and absolute control and absolute privacy being maintained at all times by the person having the unique user environment. No prior art method or device allows absolute truth to the highest probability be established when arrival at the destination is completed with instant access to all resources, information and preferences of the user environment that has traveled to such destination. Further, no prior art method or device allows the user environment in any form be provided and instantly be made available to the controller of the environment on a host computer without any regard to host resources, environment and other limitations. Further, no prior art reference the allows the unique user environment the ability to move that user environment from computer to computer so that all user defined settings and parameters for all aspects of the computer, let alone data files, applications and even operating systems are the same wherever he goes, and further then bring along with him any updates to that user environment has he moves further along.

Yet even further, to do all of the above and then leave no trace, “foot-print” on the host device is not possible in any prior art device or method. To accomplish all of the above would be a major advancement over the world of computers, and how we move information around the world, and how we do so with total control and absolute highest probability truth analysis. To do all of this with a simple “one click” single-sign on capability would be just that much more of advancement and is clearly no in the prior art.

As yet another matter of that which is not in the prior art; to do what has been suggested would be a major advancement. Well, what is further needed is the ability to do all of this syncing, updating, moving around with instant access and total privacy and with the highest level of security verification and then return the user environment to its origin and have the person in control of such user environment re-establish the new updated environment on his computer or computers again with simple “one-click” single-sign on re-synchronization. No capabilities exist in the prior art that permit such a method to be carried out or a device to effect such a method.

Given all of the above deficiencies in the prior art as stated above, further development in this area is clearly needed. No ability in the prior art exists which allows any of the above, let alone a combination of all advancements. However, other problems exist in the prior art which need improvement which, implementation alone or in combination would further advance the movement of user environments to other locations (to temporary or permanent hosts) under the controlled, secure, non-intrusive and private manner as described above.

The present invention includes an integrated system for developing, creating and for bringing to life a User-Controlled, Private, Migrating, Adaptable, Computer-Personified Profile, Representative of Myself and able to have Split Personalities, but with Highest Probability of Absolute Proof of Actual Truthfulness at any time of Identity Request.

In the preferred embodiment, the system permits the development, creation and bringing to life an infinite number of Computer-Personified Profiles representing an actual number of human beings brought into the group. Each must go through the truth test. None will have higher serial number than mine until earned. All must go through the truth test. Privacy is not an issue unless you gain access in the company. So if a user takes an executive position, balance taking that position with what they give up in privacy. They are adaptable immediately, however if they use that to take their profile home, the system strips it of security clearance and it is inspected on the way back in from home to work. The system will decide when you can have multi-personalities. The profile and any sub-profile must have the highest probability of absolute proof and always have to be able to show actual truthful profile identity.

Once created, the profile is user-controlled by the person it represents. They tell it to be private or not. They have some say to where they can migrate. But what is on the profile from network point of view there is mine. The system can permit multiple personalities. With truth yields privacy. And privacy has its advantages.

### SUMMARY OF THE INVENTION

To implement the inventive methods and devices of our invention, it is first important to establish that a profile for a user can, in fact, be authenticated. First, this is accomplished by scanning a biometric component of a person, in this case a fingerprint, using the digitally encrypted representation of the fingerprint in tandem with authentication software, validating that the person is who they say they are, and therefore allowing a log in to the computer system, network, database, or application to begin. Second, this is further enhanced by appreciating that computers are capable of having unique profiles that are user-created and defined. That is, over time a personal computer begins to mature and grow with the human user. A profile begins to grow from a point of creation, and instantly forms a unique persona different than any other like computer so that all computers diverges from all others and continue to grow and mature until each computer profile is completely different than any other. Measurable definable characteristics of each computer profile can then be used to prove they are different than another and that can be used to link a biometric characteristic to the computer user-defined profile. With the addition of biometric authentication, one person can be on the other end of a computer line or phone line, and be authenticated by linking his computer profile with an human biometric characteristic which has been previously established.

An analogy exists that a profile of computer is unique to its user just like humans beings are unique as compared to another and that he can than accept that a link between them and be established on a secure system. This again warrants acceptable that over time and through use, a personal computer begins to develop a personality that is unique and personal to the user of that particular computer device, which is defined as the computer profile.

We can allow you to secure, maintain and privatize your computing configuration environment while having the ability to take this environment wherever you travel, without the need to lug a notebook computer all through instant biometric authentication. This will give you one click mobility to your computer anywhere in the world—in your pocket. It eliminates the need for hauling a laptop and other computer devices. It introducing the personal productivity product that turns any computer into your own—in the office, at home, school, and beyond. Store and access your data, environment, and any other information on our lightweight portable transport device accessible through biometric authentication. Quickness is achieved when you purchase a new computer simply take your old personalized environment from your old computer and plug it in to your new computer and be up and running in seconds without worry of reconfiguration of your new computer or loss of important data and settings by using your biometric signature device. You will have content personalization so say goodbye to frustration when using a computer other than your own. Simply access your personally configured environment and data in seconds and get to work. This will definitely increase productivity since you can access items such as personal files, folders, email, address book, bookmarks, favorites, MP3s, personal settings including Internet privacy settings using any computer, anytime.

Security is increased across specific files, folders or settings that you desire. You have complete control over what is being accessed at all times using any computer, with biometric security in all applications.

We have the ability to provide biometric enabled single sign-on (SSO) and automated sign-off (ASO) under the control of the User, be it with a stand-alone PC or a networked PC, without the requirement of massive software and hardware infrastructure. This invention allows the ability to implement in a rapid fashion, without large amounts of training or cost. We do this by inversing the deployment of SSO and ASO. Instead of costly infrastructure, we put the implementation and the control of SSO in the fingerprints, voice print, RFID, smart card, or iris print (biometrics) of the user. With the control in the hands of the users, SSO/ASO is achieved in a matter of minutes with little to no training, versus long implementation cycles or large deployments which usually only frustrates the users. Other levels of identification and verification can be collapsed and identity checks can go straight to authentication.

We also have the ability to provide complete security on the corporate network that will maintain the movement of data and information based on biometric security. Through this biometric security we will control the movement of data to the portable storage devices that can be used to link two computers and have identical profiles. Our method and device is effectively provides product security and access permission, while automatically generating audit logs of user activity based on the biometric tag to the user. For product security, the program will invoke a biometric scan, such as a fingerprint, to validate the user as authenticated to run the program. From access permission, the program will maintain a pin vault of username and passwords for specific applications the user has registered to provide for an emulation of single sign-on capability. Also, there is an ability to deliver entertainment (music, videos, movies, etc) via broadband distribution, while maintaining copyright requirements of the property by maintaining a credential bought from the distribution arm of the entertainment property. We can therefore maintain the movement of all information under biometric security control with the option of maintaining the data integrity link with the corporate security server, and it is capable of maintaining biometric control of the link, as well as biometric control of the data moved to the portable storage device, as well as automating the log-off of a user when not within proximity of the computer.

For the purposes of this application, we have the solution to provide biometric authentication for role-play, or wearing different hats at different times of the day, and accessing the required information to make decisions quickly. It provides information in real time for each role-play as desired. A corporate employee can change identifies as required for fungible roles. For example, a staff member which provides call center overflow support can have their entire call center environment, usually more than 12 applications, customized for each end customer, complete with single sign-on capabilities. All access, product scripts, customer service applications, etc., can change based on a biometric vault and an associated account designation. We can permit complete role based login/desktop/environment/access/log-off through biometric authentication. This allows for rapid deployment of service capability or product delivery under a defined role, delivering the role environment as engineered, and authenticated under biometric authentication.

### BRIEF DESCRIPTION OF THE DRAWINGS

The invention can be best understood by those having ordinary skill in the art by reference to the following detailed description when considered in conjunction with the accompanying drawings, wherein:

FIG. 1 is a representation of a single Profile user (Guest) according to the present invention.

FIG. 2 is an illustration of networks according to the present invention.

FIG. 3 is a diagram of a single profile user according to the present invention.

FIG. 4 is a schematic diagram of a sample computer system according to the present invention.

FIG. 5 is a flow chart according to the present invention.

### DETAILED DESCRIPTION OF THE INVENTION

Reference will now be made in detail to the presently preferred embodiments of the invention, examples of which are illustrated in the accompanying drawings.

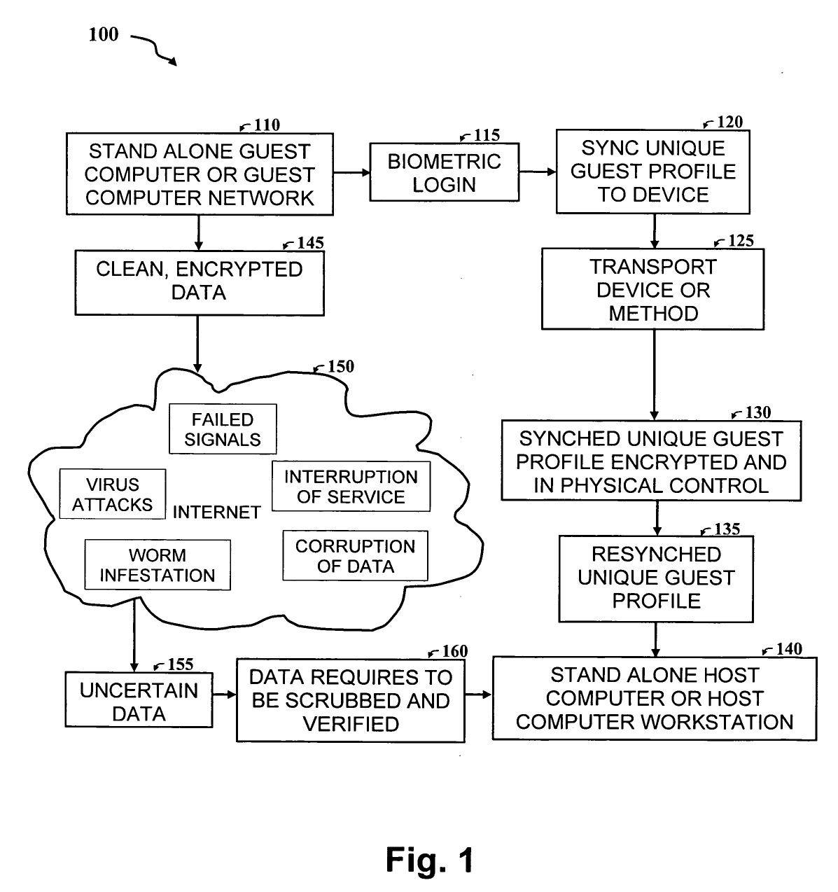

Referring to FIG. 1, a representation of a single profile user 100 according to the present invention is shown. In this a single profile user is shown circumventing the Internet 150 under biometric control and simultaneously sending some other data which goes through the Internet 150 and will probably come out through the other side and attempt to enter the Host but with complications. These complications are rooted in large amounts for complex software and hard infrastructure surrounding the internet, thereby making safe passage of communications hazardous to the safety of a corporate network, and intellectual assets in the network as represented by data, applications, files and folders. The complications, risk and costs of this environment for high risk areas can be circumvented by utilizing this invention. FIG. 1 demonstrates two paths to the Stand Alone Host. A first path through the internet with all the trappings and a second path through the present invention, decreasing risk, hardware and software infrastructure, and staff costs. The first path begins at the stand alone guest computer 110 and requires a biometric login 115 after which the profile data is synced to a device 120, possibly an external storage. The external storage is then transported 125 (or reconnected) to the second location and is a synched unique guest profile under physical control 130. The profile is then resynched 135 onto a second computer, perhaps a stand alone host 140. The second, path also starts at the stand alone guest computer 110 but includes clean but encrypted data 145 then passes through the internet 150 along with all of its potential issues including virus attacks, failed signals, interruption of service, corruption of data and worm infestation. Emanating from the internet 150 is data that is uncertain 155 that must be scrubbed and verified 160 before it can pass to the stand alone host computer 140.

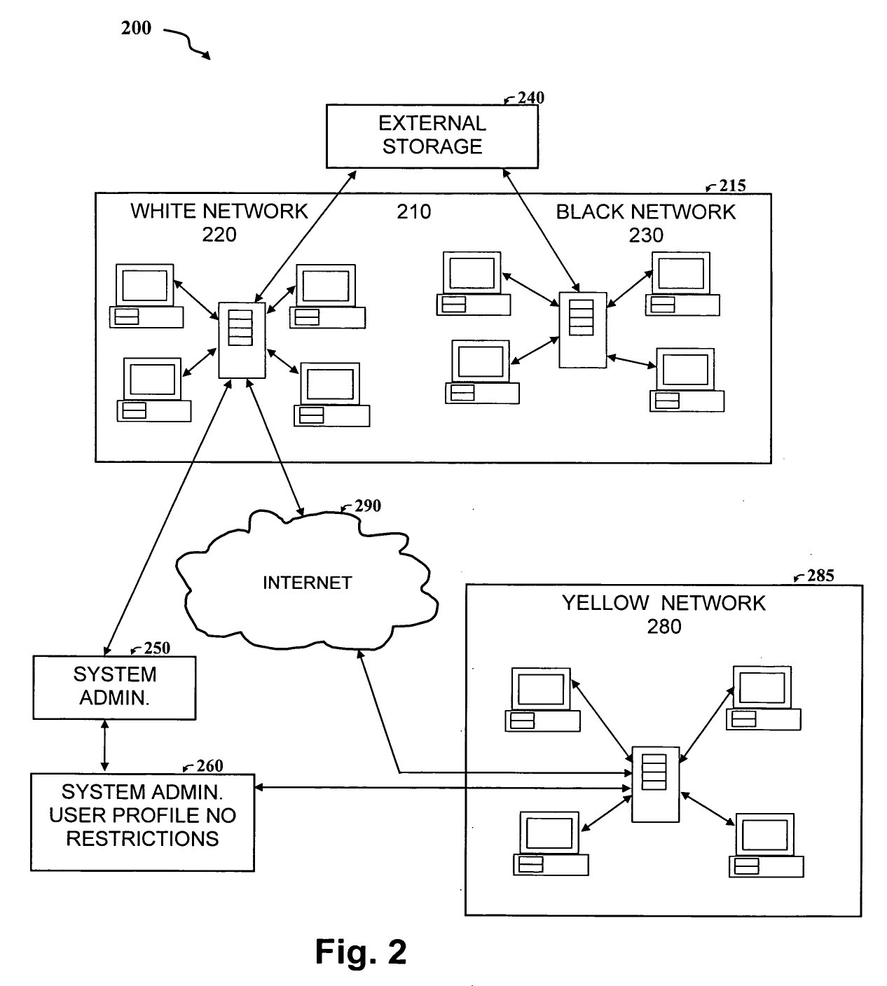

Referring to FIG. 2, two networks 200 according to the present invention are shown. The first network 210 consists of two sub-networks, the white 220, and the black 130, surrounded by a firewall 215. The white sub-network is connected to the internet 290, while the black sub-network 230 is isolated from the internet, perhaps to limit security risks regarding confidential data stored on the black sub-network 230. The yellow network 280 is also surrounded by a firewall 285. The risks of any type of unauthorized interaction between the white sub-network 220, which has a connection to the internet 290, and the black sub-network 230, where a host of corporate private assets are maintained, are too large to allow the physical connection. Yet, the problem exists where the need to have files and folders moved between the sub-networks, albeit by physically carrying a medium with the assets, does exist. Carrying the medium in normal format creates the additional issue of allowing openly readable folders/files on the physical medium transported between the white sub-network 220 and the black sub-network 230. A system administrator 250 must be trusted by network 210 to pierce firewall 215, but may have an unrestricted profile 260 for access to network 280.

This invention allows for the creation of profiles which are comprised of files and folders as designated by the user, taking these profiles synchronizing and encrypting them based on the biometric certificate received at login with the user's fingerprint, allowing for transport of the encrypted profile from one network, e.g. the white sub-network 220, to an external storage device 240 in real-time as modification are made, allowing for physical transport of the storage device to the black sub-network 230, logging in to the black sub-network 230 under biometric authentication, resynchronizing and decrypting the profiles on to the black sub-network 230. Additionally, should the user require, a guest mode operation will maintain the profile on the black sub-network 230 only as long as the user is logged in to the black sub-network. Once logged off, the profile on the black network and all user activity on the network disappears. This may include cleaning up all files created on the black network 230, perhaps wiping these files using algorithms known in the industry to assure no traces remain after deletion.

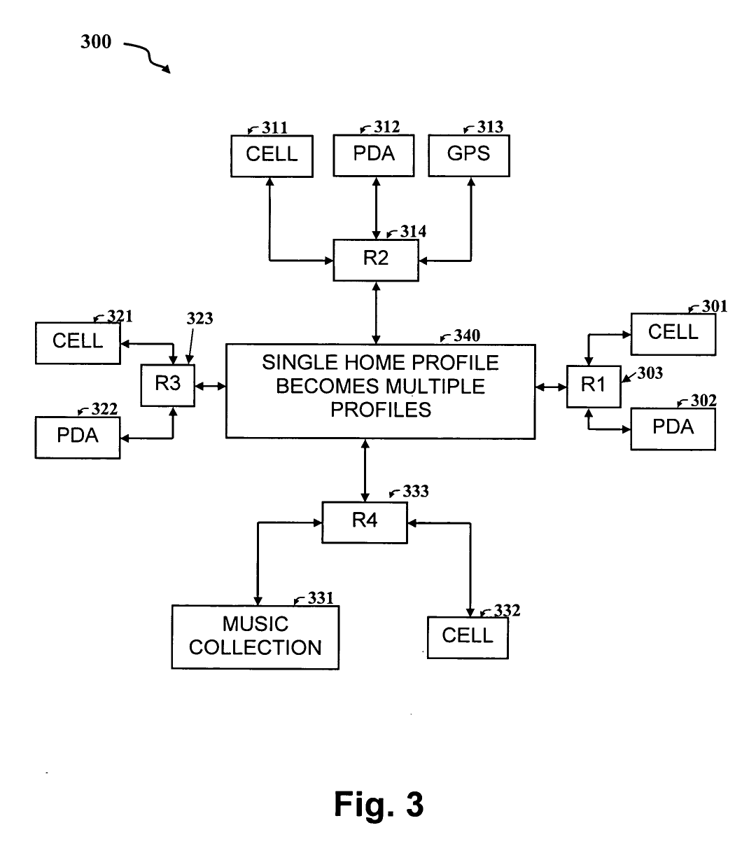

Referring to FIG. 3, a diagram of a single profile user 300 is shown. In this, a profile 340 may have four sub-role playing members based on a different fingerprint identifying them as a different role. One finger is used for Role 1 (303), where the authentication is quantified for a cell phone 301 and PDA 302. Role 2 (314) uses a different finger for a cell phone 311, a PDA 312 and GPS capability 313. Role 3(323) once again uses a cell 321 and PDA 322, only this time as a totally different identity, and role 4 (333) uses yet another fingerprint for yet another identity using a cell phone 332 and music collection 331. This invention allows for the use of a fingerprint, associated with a role definition, which allows for execution, access and viewable privileges of the user based on the fingerprint. For example, authorizing with a left hand index finger may initiate role 1 (303) wherein the user is authorized to use the cell 301 and PDA 302 under a first user name, while authorizing with a right hand index finger may initiate role 3 (323) wherein the user is authorized to use the cell 321 and PDA 322 under a second user name.

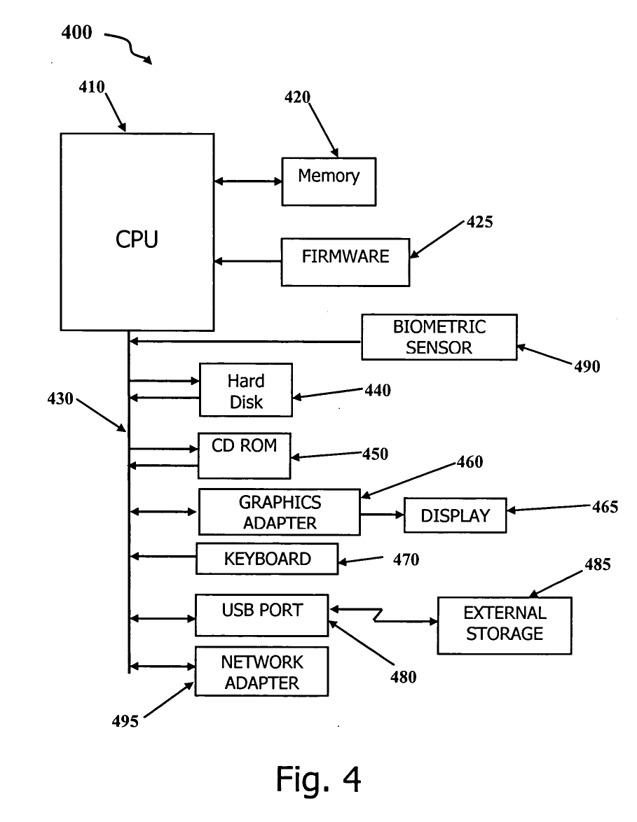

Referring to FIG. 4, a schematic block diagram of a computer-based system 400 of the present invention is shown. In this, a processor 410 is provided to execute stored programs that are generally stored within a memory 420. The processor 410 can be any processor, perhaps an Intel Pentium-4® CPU or the like. The memory 420 is connected to the processor and can be any memory suitable for connection with the selected processor 410, such as SRAM, DRAM, SDRAM, RDRAM, DDR, DDR-2, etc. The firmware 425 is possibly a read-only memory that is connected to the processor 410 and may contain initialization software, sometimes known as BIOS. This initialization software usually operates when power is applied to the system or when the system is reset. Sometimes, the software is read and executed directly from the firmware 425. Alternately, the initialization software may be copied into the memory 420 and executed from the memory 420 to improve performance.

Also connected to the processor 410 is a system bus 430 for connecting to peripheral subsystems such as a hard disk 440, a CDROM 450, a graphics adapter 460, a biometric sensor 490, a Universal Serial Bus (USB) port 480, a keyboard 470 a biometric sensor 490 and a network adapter 495. The graphics adapter 460 receives commands and display information from the system bus 430 and generates a display image that is displayed on the display 465.

In general, the hard disk 440 may be used to store programs, executable code and data persistently, while the CDROM 450 may be used to load said programs, executable code and data from removable media onto the hard disk 440. These peripherals are meant to be examples of input/output devices, persistent storage and removable media storage. Other examples of persistent storage include core memory, FRAM, flash memory, etc. Other examples of removable media storage include CDRW, DVD, DVD writeable, compact flash, other removable flash media, floppy disk, ZIP®, laser disk, etc. Other devices may be connected to the system through the system bus 430 or with other input-output functions. Examples of these devices include printers; mice; graphics tablets; joysticks; and communications adapters such as modems and Ethernet adapters.

In some embodiments, the USB port 480 may be connected to an external storage device 485. The example shown has an external storage device 485 which may be a flash drive, memory card or external hard drive. In another embodiment, the external storage may be connected to the system with an interface other than USB, perhaps IEEE 1394 (Firewire). In another embodiment, the external storage is located on a remote system connected by networking to that system, perhaps connected to a server, a Network Attached Storage device (NAS) or connected to the world-wide-web.

In some embodiments, the biometric sensor 490 may be used to encrypt profile information while in transit. Examples of a biometric sensor 490 include fingerprint scanners, voice recognition, facial recognition, retina scanners, DNA readers and iris scanners.

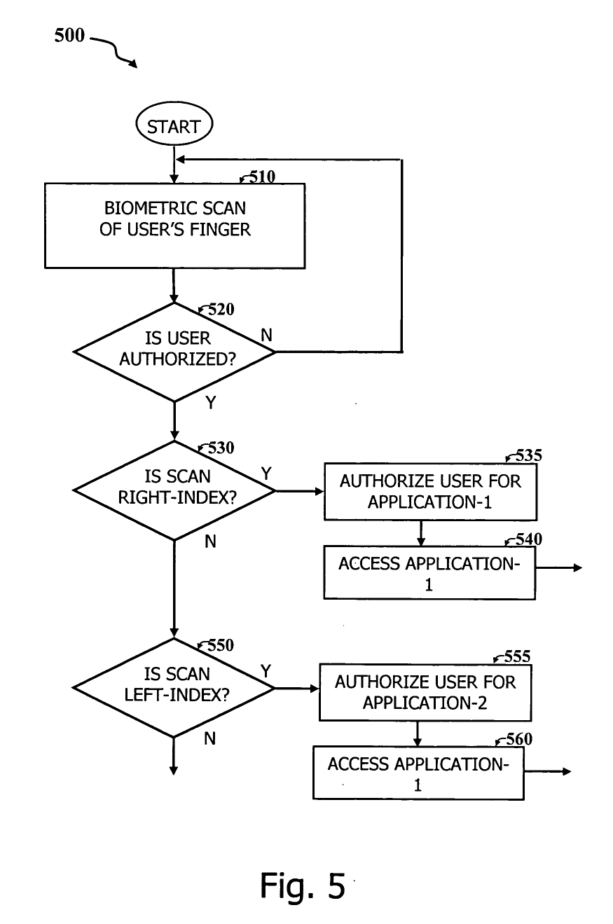

Referring to FIG. 5, a flow diagram of a computer-based system 500 of the present invention is shown. This starts with the scanning of a user's finger 510. First, the scan is compared with valid biometric signatures to determine if the user is authorized 520. If not, the step may be repeated until an authorized finger print is scanned. Once a valid biometric signature (authorized fingerprint) is found, tests are performed to determine which finger was used. In this example, a first test determines if the scan was a right index finger 530 and if so, the user is authorized for a first application, application-1 535, and the application is initiated and access allowed 540. If it is not the right index finger 530, then a second test determines if the scan was a left index finger 550 and if so, the user is authorized for a second application, application-2 555, and the application is initiated and access allowed 560. Although two tests are shown in this example, the only limit is the number of unique biometric parameters, e.g., the number of fingers. For other forms of biometric security, something other than which finger was scanned might be used. For example, for facial recognition, perhaps a wink could initiate a certain application or for retina and iris scans, a right eye could initiate a first application and a left eye could initiate a second application. The biometric scan can launch the application and also be used to authenticate the user to have access to the application. As an example, application-1 might be an on-line banking application having all of the user's financial data and account access. By scanning the right index finger, a browser may be launched and directed to go to the bank's account page, then the scan may be presented to the bank for authorization. In an embodiment of the present invention, the biometric data may be encrypted and time-stamped as to prevent duplication and playback. If, instead, the user scanned their left index finger, application-2 would be started, perhaps a database program with company financials. Again, the scanned biometric data could be presented to the database for authorization. In another embodiment, a trusted entity within the computer system could perform an authorization check of the biometric data, and if authorized, supply a stored user name and password to the application in lieu of presenting the biometric data directly.

It is believed that the system and method of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

1. A system for authenticating a user comprising:
a biometric scanner;
a plurality of biometric signatures;
a plurality of applications, each of said plurality of applications associated with at least one of said plurality of biometric signatures; and
a software module configured to accept biometric data from said biometric scanner, said software module configured to authorize said biometric data against each of said plurality of biometric signatures and if said authorization is successful, initiate an application from said plurality of applications that is associated with said biometric signature.

2. The system of claim 1, said software module further comprising:
sending authorization information to said application.

3. The system of claim 1, wherein said biometric scanner is selected from a group consisting of a fingerprint scan, an iris scan, a retina scan, a voice recognition, DNA recognition and a facial recognition.

4. The system of claim 2, wherein said authorization information includes said biometric data.

5. The system of claim 4, wherein said authorization information is encrypted.

6. The system of claim 5, wherein said authorization information is time stamped.

7. The system of claim 2, wherein said authorization information includes a user name and password that is pre-associated with said biometric data.

8. A method for authenticating a user comprising:
associating a set of biometric signatures with a set of applications;
scanning a biometric signature;
authorizing said biometric signature against each of said set of biometric signatures until a valid biometric signature is found;
if said valid biometric signature is found, initiating an associated application from said set of applications.

9. The method of claim 8, further comprising:
sending authorization information to said associated application.

10. The method of claim 8, wherein said biometric signature is selected from a group consisting of a fingerprint scan, an iris scan, a retina scan, a voice recognition, DNA recognition and a facial recognition.

11. The method of claim 9, wherein said authorization information includes said biometric signature.

12. The method of claim 11, further comprising:
encrypting said authorization information.

13. The system of claim 12, further comprising:
time-stamping said authorization information.

14. The system of claim 8, further comprising:
associating a set of user names and passwords with said set of biometric signatures; and
sending a user name and password associated with said valid biometric signature as authorization information to said associated application.

15. A system for authenticating a user comprising:
a fingerprint scanner;
a plurality of fingerprint signatures;
a plurality of applications, each of said plurality of applications associated with at least one of said plurality of fingerprint signatures; and
a software module configured to accept a fingerprint signature from said fingerprint scanner, said software module configured to authorize said fingerprint signature against each of said plurality of fingerprint signatures and if said authorization is successful, initiate an application from said plurality of applications that is associated with said fingerprint signature.

16. The system of claim 15, said software module further comprising:
sending authorization information to said application.

17. The system of claim 16, wherein said authorization information includes said biometric data.

18. The system of claim 17, wherein said authorization information is encrypted.

19. The system of claim 18, wherein said authorization information is time stamped.

20. The system of claim 16, wherein said authorization information includes a user name and password that is pre-associated with said biometric data.

21. A method for authenticating a user comprising:
associating a set of fingerprint signatures with a set of applications;
scanning a fingerprint signature;
authorizing said fingerprint signature against each of said set of fingerprint signatures until a valid fingerprint signature is found; and
if said valid fingerprint signature is found, initiating an associated application from said set of applications.

22. The method of claim 21, further comprising:
sending authorization information to said associated application.

23. The method of claim 22, wherein said authorization information includes said fingerprint signature.

24. The method of claim 23, further comprising:
encrypting said authorization information.

25. The system of claim 24, further comprising:
time-stamping said authorization information.

26. The method of claim 22, further comprising:
associating a set of user names and passwords with said set of fingerprint signatures; and
sending a user name and password associated with said valid fingerprint signature as authorization information to said associated application.
